(19) United States
(12) Patent Application Publication
(10) Pub. No.: US 2024/0359455 A1
(43) Pub. Date: Oct. 31, 2024

(54) REMOTE REGISTRATION FEEDBACK PRESSURE SENSOR ASSEMBLY FOR IMPROVED PRINT QUALITY

(71) Applicant: Stolle Machinery Company, LLC, Centennial, CO (US)

(72) Inventor: BRYON LEE KAJFOSZ, Littleton, CO (US)

(73) Assignee: Stolle Machinery Company, LLC, Centennial, CO (US)

(21) Appl. No.: 18/140,674

(22) Filed: Apr. 28, 2023

(51) Int. Cl. B41F 33/00; B41F 17/14

(52) U.S. Cl. CPC B41F 33/0072; B41F 17/14

(57) ABSTRACT

A can decorator includes a blanket wheel having a plurality of blankets disposed on an outer circumference, a plate cylinder for an inker station, the plate cylinder structured to have rotational contact with the blanket wheel, a mandrel structured to hold a can and have rotational contact with the blanket wheel, and a pressure sensor structured to sense pressure between the plate cylinder and the blanket wheel or between the mandrel and the blanket wheel.

### FIELD OF THE INVENTION

The disclosed concept relates generally to a can decorator used in the food and beverage packaging industries, and more particularly, to a pressure sensor for a can decorator.

### BACKGROUND OF THE INVENTION

High speed continuous motion machines for decorating cans, commonly referred to as “can decorator machines” or simply “can decorators,” are generally well known. FIG. 1 shows a can decorator 2. As shown in FIG. 1, a can decorator 2 includes an infeed conveyor 15, which receives cans 16 from a can supply (not shown) and directs them to arcuate cradles or pockets 17 along the periphery of spaced parallel rings secured to a pocket wheel 12. The pocket wheel 12 is fixedly secured to a continuously rotating mandrel carrier wheel 18, which in turn is keyed to a continuously rotating horizontal drive shaft 19. Horizontal spindles or mandrels (not shown), each being pivotable about its own axis, are mounted to the mandrel carrier wheel 18 adjacent its periphery. Downstream from the infeed conveyor 15, each spindle or mandrel is in closely spaced axial alignment with an individual pocket 17, and undecorated cans 16 are transferred from the pockets 17 to the mandrels. Suction applied through an axial passage of the mandrel draws the can 16 to a final seated position on the mandrel.

While mounted on a mandrel, each can 16 is decorated by being brought into engagement with a blanket (e.g., without limitation, a replaceable adhesive-backed piece of rubber) disposed on a blanket wheel of the multicolor printing unit indicated generally by reference numeral 22. Thereafter, and while still mounted on the mandrels, the outside of each decorated can 16 is coated with a protective film of varnish applied by engagement with the periphery of a varnish applicator roll (not shown) rotating on a shaft 23 in the overvarnish unit indicated generally by reference numeral 24. Cans 16 with decorations and protective coatings thereon are then transferred from the mandrels to suction cups (not shown) mounted adjacent the periphery of a transfer wheel (not shown) rotating on a shaft 28 of a transfer unit 27. From the transfer unit 27 the cans 16 are deposited on generally horizontal pins 29 carried by a chain-type output conveyor 30, which carries the cans 16 through a curing oven (not shown).

While moving toward engagement with an undecorated can 16, the blanket wheel engages a plurality of plate cylinders 31, each of which is associated with an individual inking station 32 (an exemplary eight inking stations 32 are shown in FIG. 1). Typically, each inking station 32 provides a different color ink and each plate cylinder 31 applies a different ink image segment to the blanket. All of the “ink image” segments combine to produce a “main image” that is structured to be applied to the can body. The “main image” is then transferred to undecorated cans 16 and becomes, as used herein, the “can body applied image.”

Each inking station 32 includes a plurality of rollers, or as used herein, “rolls,” that are structured to transfer a quantity of ink from a reservoir, or as used herein an “ink fountain,” to the blanket. The path that the ink travels is, as used herein, identified as the “ink train.” That is, the rolls over which the ink travels define the “ink train.” Further, as used herein, the “ink train” has a direction with the ink fountain being at the “upstream” end of the ink train and a plate cylinder 31 at the “downstream” end of the ink train.

The ink train extends over a number of rolls each of which has a purpose. As shown, the ink train starts at the ink fountain and is initially applied as a film to a fountain roll. The fountain roll is intermittently engaged by a ductor roll. When the ductor roll engages the fountain roll, a quantity of ink is transferred to the ductor roll. The ductor roll also intermittently engages a downstream roll and transfers ink thereto. The ductor roll has a “duty cycle” which, as used herein, means the ratio of the duration of the ductor roller being in contact with the fountain roller divided by the duration of a complete cycle (ductor roller in contact with the fountain roller, move to the first downstream roller, contact with first steel roller, move back to fountain roller).

The other rolls include, but are not limited to, distribution roll(s), oscillator roll(s), and transfer roll(s). Generally, these rolls are structured to distribute the ink so that a proper amount of ink is generally evenly applied to the plate cylinder 31. For example, the oscillator rolls are structured to reciprocate longitudinally about their axis of rotation so as to spread the ink as it is applied to the next downstream roll. The final roll is the plate cylinder 31 which applies the ink to the blanket. It is understood that each inking station 32 applies an “ink image” of a single selected color to the blanket and that each inking station 32 must apply its ink image in a proper position relative to the other ink images so that the main image does not have offset ink images.

Pressure is also relevant to properly applying ink images. Too much or too little pressure affects the quality of the ink image. In current can decorators, the best available information on pressure comes in the form of a distance measurement taken between relevant printing surfaces. However, the clearance distance is not an entirely accurate or complete indicator of pressure.

There remains room for improvement in can decorators.

### SUMMARY OF THE INVENTION

According to an aspect of the disclosed concept, a can decorator comprises: a blanket wheel having a plurality of blankets disposed on an outer circumference; a plate cylinder for an inker station, the plate cylinder structured to have rotational contact with the blanket wheel; a mandrel structured to hold a can and have rotational contact with the blanket wheel; and a pressure sensor structured to sense pressure between the plate cylinder and the blanket wheel or between the mandrel and the blanket wheel.

According to an aspect of the disclosed concept, a method of adjusting pressure in a can decorator having a blanket wheel having a plurality of blankets disposed on an outer circumference, a plate cylinder for an inker station, the plate cylinder structured to have rotational contact with the blanket wheel, and a mandrel structured to hold a can and have rotational contact with the blanket wheel comprises: providing a pressure sensor structured to sense pressure between the plate cylinder and the blanket wheel or between the mandrel and the blanket wheel; sensing a first pressure between the plate cylinder and the blanket wheel or between the mandrel and the blanket wheel; determining a target pressure; and adjusting a position of at least one of the plate cylinder, the blanket wheel, and the mandrel such that the first pressure is adjusted to the target pressure.

### BRIEF DESCRIPTION OF THE DRAWINGS

A full understanding of the invention can be gained from the following description of the preferred embodiments when read in conjunction with the accompanying drawings in which:

FIG. 1 is an elevation view of a can decorator;

FIG. 2 is a view of a plate cylinder and blanket wheel of a can decorator including a pressure sensor in accordance with an example embodiment of the disclosed concept;

FIG. 3 is a view of a blanket wheel and a mandrel of a can decorator having a pressure sensor in accordance with an example embodiment of the disclosed concept;

FIG. 4 is a view of a blanket wheel and a mandrel of a can decorator having a pressure sensor in accordance with an example embodiment of the disclosed concept;

FIG. 5 is a schematic diagram of a plate cylinder including a pressure sensor in accordance with an example embodiment of the disclosed concept; and

FIG. 6 is a schematic diagram of a plate cylinder including a pressure sensor in accordance with an example embodiment of the disclosed concept.

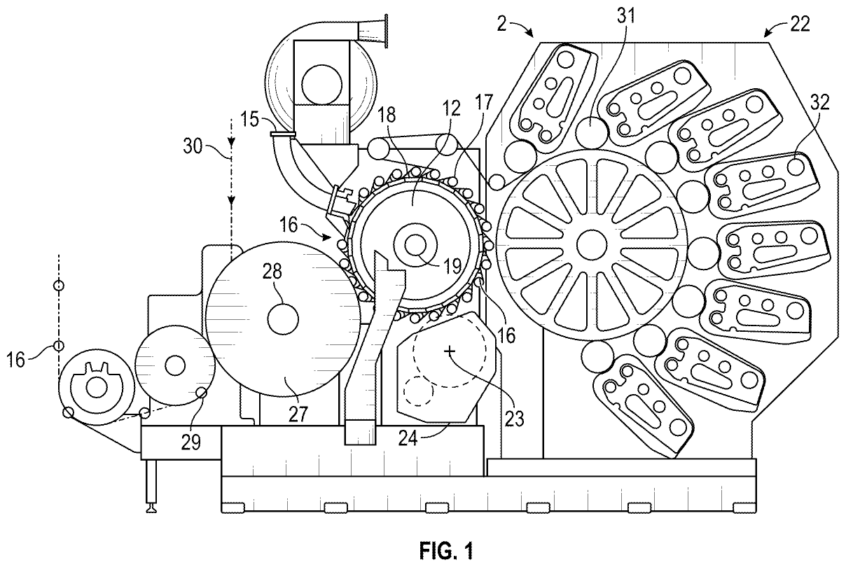

### DETAILED DESCRIPTION OF THE INVENTION

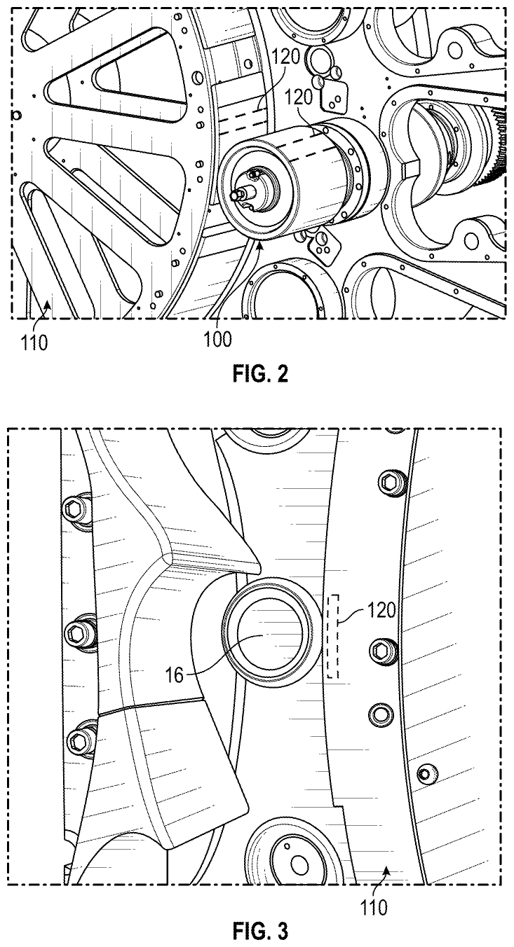

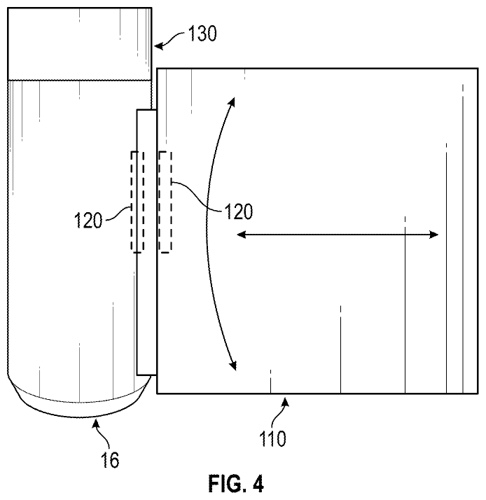

FIG. 2 is a view of a plate cylinder 100 and blanket wheel 110 with a pressure sensor 120 to sense pressure between the plate cylinder 100 and blanket wheel 110 in accordance with an example embodiment of the disclosed concept. For economy of disclosure, pressure sensors 120 are shown on both the plate cylinder 100 and the blanket wheel 110. However, it will be appreciated that a pressure sensor 120 may be included on only one of the plate cylinder 100 and blanket wheel 110 without departing from the scope of the disclosed concept.

The plate cylinder 100 and blanket wheel 110 are in rolling contact with each other. Their point of contact may be referred to as a nip. The pressure sensor 120 is structured to sense the pressure at the nip where the plate cylinder 100 and blanket wheel 110 are in contact. In some example embodiments, the pressure sensor 120 is structured to continuously sense pressure at the nip. In some example embodiments, the pressure sensor is structured to intermittently sense pressure at the nip. In example embodiments where the pressure sensor 120 is disposed on the plate cylinder 100, the pressure sensor 120 may extend an entire length of the plate cylinder 100 or a portion of the length of the plate cylinder 100. The pressure sensor 120 may also extend around an entire circumference of the plate cylinder 100 or a portion of the circumference of the plate cylinder 100. In example embodiments where the pressure sensor 120 extends the entire length and circumference of the plate cylinder 100, the pressure sensor 120 may provide continuous pressure sensing along the entire length of the nip. When the pressure sensor 120 extends a portion of the circumference of the plate cylinder 100, the pressure sensor 120 will provide intermittent pressure of the nip. That is, as the plate cylinder 100 rotates, the pressure sensor 120 will provide pressure sensing of the nip when the pressure sensor 120 is located at the nip. As the plate cylinder 100 continues to rotate, the pressure sensor 120 will move away from the nip where there will be a slight pause in pressure sensing of the nip, and then resume pressure sensing of the nip as the pressure sensor 120 is again located at the nip due to rotation of the plate cylinder 120. In example embodiments where the pressure sensor 120 extends a portion of the length of the plate cylinder 100, the pressure sensor 120 will provide pressure sensing along the portion of the nip corresponding to its length.

In example embodiments where the pressure sensor 120 is on the blanket wheel 110, the pressure sensor 120 may correspond to all or a portion of the area of a blanket of the blanket wheel 110. Pressure sensors 120 may be included in all or a selected one or more of the blankets of the blanket wheel 110.

In some example embodiments, the pressure sensor 120 may be disposed in or behind a surface of the plate cylinder 100 or blanket wheel 110. The pressure sensor 120 may use any suitable pressure sensing device to sense pressure. It will be appreciated that the pressure sensor 120 may be composed of multiple pressure sensing devices, for example an array of pressure sensing devices spread across the area of the pressure sensor 120. It will also be appreciated that in some example embodiments, the pressure sensor 120 may include only one pressure sensing device.

FIGS. 2 and 3 are views of the blanket wheel 110 and a mandrel 130 including pressure sensors 120 to sense the pressure between the blanket wheel 110 and the mandrel 130 in accordance with an example embodiment of the disclosed concept. For economy of disclosure, pressure sensors 120 are shown on both the mandrel 130 and the blanket wheel 110. However, it will be appreciated that a pressure sensor 120 may be included on only one of the mandrel 130 and blanket wheel 110 without departing from the scope of the disclosed concept.

Similar to the plate cylinder 100 and blanket wheel 110, the mandrel 130 and blanket wheel 110 are in rolling contact with each other either directly or via a can 16 disposed on the mandrel 130. Their point of contact may be also referred to as a nip. The pressure sensor 120 is structured to sense the pressure at the nip where the mandrel 130 and blanket wheel 110 are in contact. As with the plate cylinder 100 and blanket wheel 110, in some example embodiments, the pressure sensor 120 is structured to continuously sense pressure at the nip between the mandrel 130 and blanket wheel 110, and in some example embodiments, the pressure sensor is structured to intermittently sense pressure at the nip between the mandrel 130 and blanket wheel 110.

In example embodiments where the pressure sensor 120 is on the blanket wheel 110, the pressure sensor 120 may correspond to all or a portion of the area of a blanket of the blanket wheel 110. Pressure sensors 120 may be included in all or a selected one or more of the blankets of the blanket wheel 110.

In example embodiments where the pressure sensor 120 is on the mandrel 130, the pressure sensor 120 may extend all or a portion of the length of the mandrel 130, as well as all or a portion of the circumference of the mandrel 130. Similar to the pressure sensor 120 on the plate cylinder 100, the pressure sensor 120 on the mandrel 130 may intermittently or continuously sense pressure between the mandrel 130 and the blanket wheel 110 depending on the extent of the circumference of the mandrel 130 the pressure sensor 120 covers.

It will be appreciated that pressure sensors 120 may be disposed on all of the plate cylinder 100, blanket wheel 110, and mandrel 130, on one of the plate cylinder 100, blanket wheel 110, and mandrel 130, or on any combination of the plate cylinder 100, blanket wheel 110, and mandrel 130 without departing from the scope of the disclosed concept. It will also be appreciated that the pressure sensor 120 may be disposed on a selected plate cylinder 100, multiple plate cylinders 100, or all plate cylinders 100 in a can decorator without departing from the scope of the disclosed concept. It will further be appreciated that the pressure sensor 120 may be disposed on one blanket of the blanket wheel 110, multiple blankets of the blanket wheel 110, or all blankets of the blanket wheel 110 of a can decorator without departing from the scope of the disclosed concept. It will yet further be appreciated that the pressure sensor 120 may be disposed on a selected mandrel 130, multiple mandrels 130, or all mandrels 130 of a can decorator without departing from the scope of the disclosed concept.

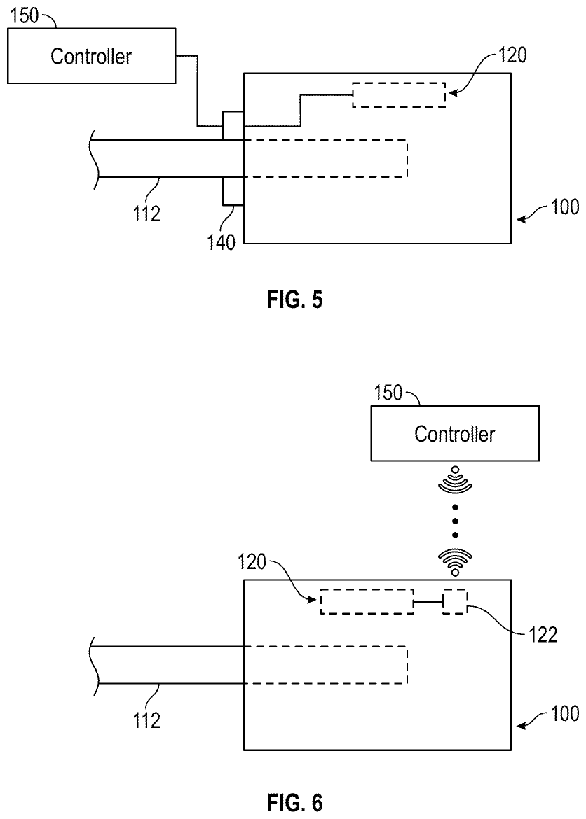

FIG. 5 is a schematic diagram of a plate cylinder 100 including a pressure sensor 120 in accordance with an example embodiment of the disclosed concept. The plate cylinder 100 is mounted on a plate cylinder shaft 112. A slip ring 140 is disposed on the plate cylinder shaft 112. The slip ring 140 is operable to connect to the pressure sensor 120 to receive the output sensed pressure from the pressure sensor 120. The slip ring 140 is also connected to a controller 150 and is structured to provide the received output of the pressure sensor 120 to the controller 150. The slip ring 140 includes a rotating portion that rotates in conjunction with rotation of the plate cylinder 100 and a static portion that does not rotate. The rotating portion of the slip ring 140 is structured to receive the output of the pressure sensor 120 and communicate the output to the static portion of the slip ring 140. The controller 150 is connected to the static portion of the slip ring 140 such that the controller 150 may receive the output of the pressure sensor 120 without needed to rotate. In some example embodiments, the controller 150 may be part of a control system for the can decorator.

It will be appreciated that the slip ring 140 may also be employed in embodiments where the pressure sensor 120 is disposed on the blanket wheel 110 or the mandrel 130. For example, the slip ring 140 may be disposed on a shaft of the blanket wheel 110 when the pressure sensor 120 is disposed on the blanket wheel 110 and the slip ring 140 may be disposed on a shaft of the mandrel 130 when the pressure sensor is disposed on the mandrel 130.

FIG. 6 is a schematic diagram of a plate cylinder 100 including a pressure sensor 120 in accordance an example embodiment of the disclosed concept. In the example embodiment shown in FIG. 6, the pressure sensor 120 is connected to a wireless communication unit 122. The wireless communication unit 122 is structured to receive the output of the pressure sensor 120 and to wirelessly communicate the output of the pressure sensor 120 to the controller 150. It will be appreciated that in some example embodiments, the wireless communication unit 122 may be integrated into the pressure sensor 120. In some example embodiments, the controller 150 may be part of a control system for the can decorator. It will also be appreciated that the wireless communication unit 122 may also be employed in embodiments where the pressure sensor 120 is disposed on the blanket wheel 110 or the mandrel 130.

In some example embodiments, rather than placing the pressure sensor 120 in or behind surfaces of the plate cylinder 100 or mandrel 130, the pressure sensor 120 may be disposed, for example, on the mounting base of the shaft of the plate cylinder 100 or mandrel 130 to the can decorator frame. The force on the shaft may be used as a measurement of the pressure between the plate cylinder 100 and the blanket wheel 110 or the mandrel 130 and the blanket wheel 110. In some example embodiments of the disclosed concept, the pressure sensor 120 may be placed directly on the frame of the can decorator to calculate the equivalent force between the plate cylinder 100 and the blanket wheel 110 or the mandrel 130 and the blanket wheel 110.

In accordance with various example embodiments of the disclosed concept, the pressure sensor 120 senses the pressure between the plate cylinder 100 and the blanket wheel 110 and/or between the mandrel 130 and the blanket wheel 110. The measurement of actual pressure between the plate cylinder 100 and blanket wheel 110 or between the mandrel 130 and blanket wheel 110 is more accurate than prior can decorators where the clearance between these components was measured. Additionally, in some example embodiments, the pressure is sensed across the entire contacting surfaces, giving a more complete sensing of pressure. Pressure measured across the entire surface is useful in paralleling and toe-in processes of a plate cylinder and blanket wheel.

In some example embodiments, the can decorator includes a controller, such as the controller 150 shown in FIGS. 5 and 6. The controller 150 may control various aspects of the can decorator including relative positions between components such as the plate cylinder 100, blanket wheel 110, and mandrel 130. The actual pressure between the plate cylinder 100 and blanket wheel 110 and between the mandrel 130 and blanket wheel 110 are important in printing high quality cans. In some example embodiments of the disclosed concept, the controller 150 may use the output of the pressure sensor 120 to adjust the relative positions of the plate cylinder 100, blanket wheel 110, and mandrel 130 to obtain the desired pressures between these components. For example, the controller 150 may maintain target pressures between the components, and raise or lower the pressure between the components to the target pressure based on the output of the pressure sensor 120. In some example embodiments of the disclosed concept, the process may be automated, thus maintaining high print quality and reducing excess wear on components of the can decorator.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

1. A can decorator comprising:
a blanket wheel having a plurality of blankets disposed on an outer circumference;
a plate cylinder for an inker station, the plate cylinder structured to have rotational contact with the blanket wheel;
a mandrel structured to hold a can and have rotational contact with the blanket wheel; and
a pressure sensor structured to sense pressure between the plate cylinder and the blanket wheel or between the mandrel and the blanket wheel,
wherein the pressure sensor is disposed on the mandrel, the plate cylinder or at least one blanket of the blanket wheel.

2. The can decorator of claim 1, wherein the pressure sensor is disposed on the plate cylinder and is structured to sense pressure between the plate cylinder and the blanket wheel.

3. The can decorator of claim 2, wherein the plate cylinder has an outer circumferential area, and wherein the pressure sensor is structured to sense pressure over the entire outer circumferential area of the plate cylinder.

4. The can decorator of claim 2, wherein the plate cylinder has an outer circumferential area, and wherein the pressure sensor is structured to sense pressure over a portion of the outer circumferential area of the plate cylinder.

5. The can decorator of claim 1, wherein the pressure sensor is disposed on the mandrel and is structured to sense pressure between the mandrel and the blanket wheel.

6. The can decorator of claim 5, wherein the mandrel has an outer circumferential area, and wherein the pressure sensor is structured to sense pressure over the entire outer circumferential area of the mandrel.

7. The can decorator of claim 5, wherein the mandrel has an outer circumferential area, and wherein the pressure sensor is structured to sense pressure over a portion of the outer circumferential area of the mandrel.

8. The can decorator of claim 1, wherein the pressure sensor is disposed on at least one blanket of the blanket wheel and is structured to sense pressure between the plate cylinder and the blanket wheel and between the mandrel and the blanket wheel.

9. The can decorator of claim 8, wherein the at least one blanket of the blanket wheel has a surface area, and wherein the pressure sensor is structured to sense pressure over the entire surface area of the at least one blanket.

10. The can decorator of claim 8, wherein the at least one blanket of the blanket wheel has a surface area, and wherein the pressure sensor is structured to sense pressure over a portion of the surface area of the at least one blanket.

11. The can decorator of claim 1, further comprising:
a slip ring disposed on a shaft of one of the plate cylinder, the blanket wheel, and the mandrel, the slip ring having a rotating portion connected to the pressure sensor and structured to receive an output of the pressure sensor and a static portion structured to connect to a controller and provide the output of the pressure sensor to the controller.

12. The can decorator of claim 1, further comprising:
a wireless communication unit connected to the pressure sensor and structured to receive an output of the pressure sensor, wherein the wireless communication unit is structured to wirelessly communicate the output of the pressure sensor to a controller.

13. The can decorator of claim 1, further comprising:
a controller structured to receive an output of the pressure sensor.

14. The can decorator of claim 13, wherein the controller is structured to control relative positions of the plate cylinder and the blanket wheel or the mandrel and the blanket wheel based on the output of the pressure sensor.

15. (canceled)

16. A method of adjusting pressure in a can decorator having a blanket wheel having a plurality of blankets disposed on an outer circumference, a plate cylinder for an inker station, the plate cylinder structured to have rotational contact with the blanket wheel, and a mandrel structured to hold a can and have rotational contact with the blanket wheel, the method comprising:
providing a pressure sensor structured to sense pressure between the plate cylinder and the blanket wheel or between the mandrel and the blanket wheel, wherein the pressure sensor is disposed on the mandrel, the plate cylinder or at least one blanket of the blanket wheel;
sensing a first pressure between the plate cylinder and the blanket wheel or between the mandrel and the blanket wheel;
determining a target pressure; and
adjusting a position of at least one of the plate cylinder, the blanket wheel, and the mandrel such that the first pressure is adjusted to the target pressure.
